(19) United States
(12) Patent Application Publication
(10) Pub. No.: US 2007/0154295 A1
(43) Pub. Date: Jul. 5, 2007

(54) Side loading vehicle system

(75) Inventor: Sanjeev Kuriakose, Shippensburg, PA (US)

Correspondence Address: FOLEY & LARDNER LLP, 777 EAST WISCONSIN AVENUE, MILWAUKEE, WI, 53202-5306, US

(73) Assignee: Jerr-Dan Corporation

(21) Appl. No.: 11/607,121

(22) Filed: Nov. 30, 2006

Related U.S. Application Data
(60) Provisional application No. 60/741,152, filed on Dec. 1, 2005.

(51) Int. Cl. B60P 1/64; B65F 3/00

(52) U.S. Cl. 414/546; 414/498; 414/542

(57) ABSTRACT

A side loading recovery vehicle is provided. The recovery vehicle includes a movable chassis and a side loading vehicle system. The side loading vehicle system includes a sub-frame assembly supported by the chassis, a mast structure movably supported relative to the sub-frame and configured for lateral movement relative to the chassis, a boom movably supported relative to the mast structure and configured for vertical movement relative to the mast structure, and one or more engaging arms supported by the boom and configured to engage the wheels of a vehicle to be towed, the engaging arms extending downward from the boom at least partially in a vertical direction. At least one of the engaging arms being configured to move between an open position and a closed position to accommodate vehicle with varying wheel sizes. The side loading vehicle system is configured to load vehicles from both the first lateral side and the second lateral side of the chassis.

### CROSS REFERENCE TO RELATED PATENT APPLICATIONS

The present application claims the benefit under 35 U.S.C. § 119(e) of U.S. Provisional Application No. 60/741,152, having a filing date of Dec. 1, 2005, titled “Side Loading Vehicle System,” the disclosure of which is hereby incorporated by reference in its entirety.

### BACKGROUND

The present application relates generally to the field of vehicle lifting and towing equipment. More specifically, the present application relates to systems for lifting a vehicle to be towed from a lateral side of the vehicle.

Vehicle lifting and towing apparatuses are generally designed to engage a vehicle to be towed or transported from the front or rear of such vehicle. While there exist towing apparatuses which allow a recovery vehicle to approach the vehicle to be towed at an angle (e.g., pivoting wheel cradles, etc.), the towing apparatuses are still engaging the front or rear of the vehicle to be towed. In certain applications, in may be burdensome or impractical to engage the vehicle to be towed from the front or rear of the vehicle. For example, if the vehicle to be towed is parallel parked between two vehicles that are substantially close to the vehicle to be towed, it may be difficult for an operator to remove the vehicle from its location. Further, in towing apparatuses configured to engage a front or rear portion of the vehicle to be towed, the operator is often required to exit the cab of the recovery vehicle in order to properly align the towing apparatus.

Accordingly, there is a need for a lifting or towing apparatus configured to engage a lateral side of a vehicle to be towed. There is also a need for a lifting or towing apparatus configured to extend from a lateral side of a recovery vehicle. There is also a need for a side loading recovery system that can be used to lift vehicles from either lateral side of a recovery vehicle. There is also a need for a side loading recovery system configured to engage vehicles having varying wheelbase lengths. There is also a need for a side loading recovery system configured to engage vehicles having varying sized wheels. There is also a need for a side loading recovery system that can be fully operated by an operator while within the vehicle cab.

It would be desirable to provide a side loading vehicle system that provides one or more of these or other advantageous features as may be apparent to those reviewing this disclosure. The teachings disclosed extend to those embodiments which fall within the scope of the appended claims, regardless of whether they accomplish one or more of the above-mentioned needs.

### SUMMARY

One exemplary embodiment relates to a side loading vehicle lifting apparatus. The lifting apparatus includes a frame assembly, a mast structure movably supported by the frame assembly and configured for horizontal movement, a boom movably supported by the mast structure and configured for vertical movement; and one or more arm assemblies supported by the boom and extending at least partially downward therefrom. The arm assemblies each have a width that can be expanded and retracted in using an actuator device.

Another exemplary embodiment relates to recovery vehicle. The recovery vehicle includes a movable chassis and a side loading vehicle system. The side loading vehicle system includes a sub-frame assembly supported by the chassis, a mast structure movably supported relative to the sub-frame and configured for lateral movement relative to the chassis, a boom movably supported relative to the mast structure and configured for vertical movement relative to the mast structure, and one or more engaging arms supported by the boom and configured to engage the wheels of a vehicle to be towed, the engaging arms extending downward from the boom at least partially in a vertical direction. At least one of the engaging arms being configured to move between an open position and a closed position to accommodate vehicle with varying wheel sizes. The side loading vehicle system is configured to load vehicles from both the first lateral side and the second lateral side of the chassis.

Another exemplary embodiment relates to a method of loading a vehicle to be towed onto a recovery vehicle. The method includes the steps of positioning the recovery vehicle adjacent to and parallel with the vehicle to be towed, moving a mast structure in a lateral direction relative to the recovery vehicle, lowering a boom section relative to the mast structure, providing a first wheel engaging arm supported at the boom for a first set of wheels and a second engaging arm supported at the boom for engaging a second set of wheels, adjusting the width of each engaging arm in a fore and aft direction of the recovery vehicle; engaging the wheels of the vehicle to be towed with forks outwardly extending from arms supported by the boom section, raising the boom section in a vertical direction to raise the vehicle, and sliding the mast structure in a lateral direction to move the vehicle over a chassis of the recovery vehicle.

Another exemplary embodiment relates to a recovery vehicle comprising a chassis having a first lateral side and a second lateral side, an operator cab supported by the chassis, and a side loading vehicle system. The side loading vehicle system comprises a sub-frame assembly supported by the chassis, a mast structure movably supported relative to the sub-frame and configured for lateral movement relative to the chassis, a boom movably supported relative to the mast structure and configured for vertical movement relative to the mast structure, and first and second engaging arms supported by the boom and configured to engage wheels of a vehicle to be towed from both the first and second lateral sides. The recovery vehicle further comprises a surveillance system coupled to the lift system which allows an operator to remain in the operator cab while engaging a vehicle with the lift system.

### BRIEF DESCRIPTION OF THE DRAWINGS

FIG. 1 is a perspective view of a side loading vehicle system according to an exemplary embodiment shown in a deployed position.

FIG. 2 is a photograph showing a rear view of the side loading vehicle system of FIG. 1 shown in an intermediate position.

FIG. 3 is a photograph showing a perspective view of the side loading vehicle system of FIG. 1 shown in a retracted position.

FIG. 4 is a perspective view of a sub-frame assembly according to an exemplary embodiment.

FIG. 5 is another perspective view of the sub-frame assembly of FIG. 4.

FIG. 6 is a partial perspective view of the side loading vehicle system according to an exemplary embodiment.

FIG. 7 is a photograph showing a perspective view of a mast structure moving relative to the sub-frame assembly of FIG. 4.

FIG. 8 is another photograph showing a perspective view of the mast structure moving relative to the sub-frame assembly of FIG. 4.

FIG. 9 is a photograph showing a perspective view of a wear pad on the mast structure of FIG. 7.

FIG. 10 is a side view of the side loading vehicle system of FIG. 6.

FIG. 11 is a partial perspective view of the side loading vehicle system of FIG. 6.

FIG. 12 is a photograph showing a perspective view of a boom assembly of the side loading vehicle system of FIG. 1.

FIG. 13 is a photograph showing a side view of a front vehicle engaging arm according to an exemplary embodiment.

FIG. 14 is a photograph showing a side view of a rear vehicle engaging arm according to an exemplary embodiment.

FIG. 15 is a photograph showing a side view of a vehicle engaging arm according to an exemplary embodiment in an open position.

FIG. 16 is a photograph showing a side view of the vehicle engaging arm of FIG. 15 shown in a closed position.

FIG. 17 is a photograph showing a perspective view of forks engaging a wheel of a vehicle to be transported.

FIG. 18 is a photograph showing a perspective view of lower ends of a vehicle engaging arm with adjustable forks.

FIG. 19 is a perspective view of lower ends of a vehicle engaging arm with adjustable forks similar to FIG. 18.

FIG. 20 is a perspective view of an outrigger according to an exemplary embodiment.

FIG. 21 is a photograph of a display screen according to an exemplary embodiment showing the positioning of the side loading vehicle system.

FIG. 22 is a photograph of a display screen of FIG. 21 along with a user interface used to control the side loading vehicle system.

FIG. 23 is a perspective view of a display screen and user interface similar to those of FIG. 22.

FIG. 24 is a photograph of a video surveillance according to an exemplary embodiment.

### DETAILED DESCRIPTION

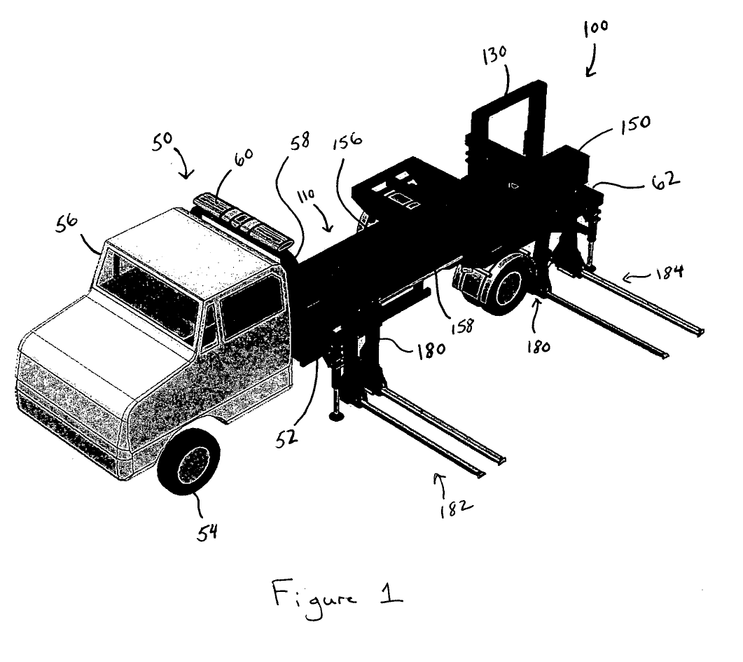

Referring to FIG. 1, a side loading vehicle system 100 (e.g., lifting system, fork lift, etc.) supported by a movable chassis is shown according to an exemplary embodiment. The side loading vehicle system 100 is capable of engaging and lifting a vehicle to be transported from a lateral side of the vehicle. The side loading vehicle system 100 generally comprises a sub-frame assembly 110, a mast structure 130 movably supported relative to the sub-frame assembly 110, a boom assembly 150 movably supported relative to the mast structure 130, and one or more vehicle engaging arms 180 supported by the boom assembly 150. The side loading vehicle system 100 is further shown as including an outrigger system 300 configured to stabilize the movable chassis (e.g., reduce the likelihood that the movable chassis will tip over and/or slide, etc.) when a vehicle to be transported is being lifted by the vehicle engaging arms 180.

According to the exemplary embodiment illustrated in FIG. 1, the side loading vehicle system 100 is capable of engaging and lifting a vehicle to be transported from either lateral side of the movable chassis. To provide for this feature, the one or more vehicle engaging arms 180 are selectively reconfigurable depending on whether the vehicle to be transported is positioned along a first lateral side (e.g., right side, etc.) of the movable chassis or a second lateral side (e.g., left side, etc.) of the movable chassis. According to various alternative embodiments, the side loading vehicle system 100 may be configured to engage and lift a vehicle to be transported from only one lateral side of the movable chassis. According to further alternative embodiments, the side loading vehicle system 100 may be positioned along a front and/or rear portion of the movable chassis rather than a lateral side. Further still, the side loading vehicle system 100 may be configured to engage a vehicle to be transported from the front or rear of such vehicle.

The side loading vehicle system 100 advantageously provides a system that can effectively and efficiently engage and lift a vehicle that is parallel parked or otherwise parked in a position for which access to the front or rear of the vehicle is limited. Further, such a system can be operated without requiring the operator to exit the cab via an image producing surveillance system (e.g., video cameras in combination with display screen, etc.) which allows an operator to monitor the positioning of the lift device relative to the vehicle to be towed all while remaining in the operator cab. Such a feature may save valuable time for the operator and/or may reduce safety hazards that may otherwise exist if the operator was required to exit the cab.

Referring further to FIG. 1, the side loading vehicle system 100 is shown in conjunction with a transporter vehicle (e.g., tow truck, recovery vehicle, flat-bed, etc.), referred to generally herein as a carrier 50. The carrier 50 generally includes a chassis 52 (e.g., a truck bed frame, etc.) functioning as a support structure for the components of the carrier 50 which is typically in the form of a frame assembly. According to an exemplary embodiment, the chassis 52 includes first and second frame members that are arranged as two generally parallel chassis rails extending in a fore and aft direction (i.e., a longitudinal direction of the carrier 50). The first and second frame members are configured as elongated structural or supportive members (e.g., a beam, channel, tubing, extrusion, etc.) spaced apart laterally and defining a void or cavity (not show) which generally constitutes the centerline of the carrier 50.

A plurality of drive wheels 54 are rotatably coupled to the chassis 52. The number and/or configuration of the wheels 54 may vary depending on the embodiment. According to an exemplary embodiment, the carrier 50 utilizes six wheels 54 (a tandem wheel set operably coupled via a rear axle (not shown) at a rear portion of the chassis and a single wheel set at a front portion of the chassis). According to various alternative embodiments, the carrier 50 may have any number of wheel configurations including, but not limited to, four, eight, or twelve wheels.

The carrier 50 is further shown as including an occupant compartment or cab 56 supported at a front end of the chassis 52 which includes an enclosure or area capable of receiving a human operator or driver. The cab 56 includes controls associated with the manipulation of the carrier 50 (e.g., steering controls, throttle controls, etc.) and optionally may include controls for manipulating the side loading vehicle system 100 and/or a secondary or auxiliary tow system (not shown) such as a known or otherwise suitable wheel lift system provided at the rear portion of the chassis 52. As detailed below, cab 52 may also include a display monitor configured to receive various images from a surveillance system (e.g., video cameras, etc.) supported on the vehicle which allows an operator to monitor the positioning of the lift device relative to the vehicle to be towed all while remaining in the operator cab.

It should be understood that, although the side loading vehicle system 100 is described herein with reference to the carrier 50, the side loading vehicle system 100 disclosed herein may be applied to, and find utility in, other types of transporter vehicles as well. For example, the side loading vehicle system 100 may be suitable for use with vehicles configured to transport containers, industrial equipment, or any other transporter vehicle wherein it would be desirable to engage a load from a lateral side of a movable chassis.

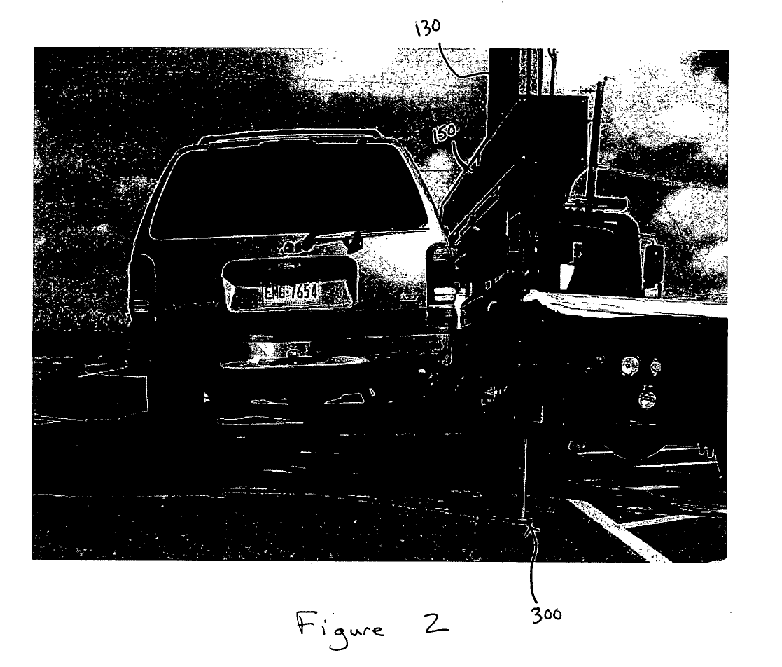

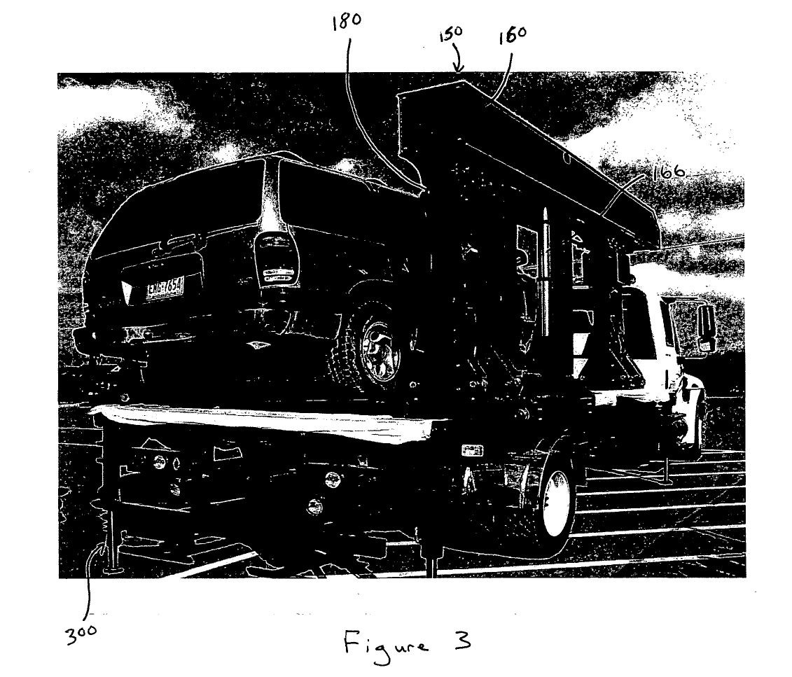

Referring to FIGS. 1 through 3, the side loading vehicle system 100 is shown in a number of different positions. The side loading vehicle system 100 is configured to be selectively moved between a first position (e.g., loading position, extended position, etc.), referred to generally herein as a deployed position, and a second position (e.g., transport position, stowed position, etc.), referred to generally herein as a retracted position. FIG. 1 shows the side loading vehicle system 100 in the deployed position. In the deployed position, the side loading vehicle system 100 is lowered to a position wherein at least a portion of the system outwardly extends from a lateral side of the chassis 52. In this position, the side loading vehicle system 100 is configured to engage a load (e.g., a disabled and/or illegally parked vehicle, etc.) to be transported. FIG. 2 shows the side loading vehicle system 100 in an intermediate position (i.e., a position between the deployed position and the retracted position). In the intermediate position, the side loading vehicle system 100 is configured to move vertically to either raise or lower the load. FIG. 3 shows the side loading vehicle system 100 in the retracted position. In the retracted position, the side loading vehicle system 100 is raised to a position wherein at least a portion of the side loading vehicle system 100 partially overlaps or is otherwise disposed about the chassis 52.

According to an exemplary embodiment, the side loading vehicle system 100 is moved from the deployed position to the retracted position by first moving the boom assembly 150 in a vertical direction relative to the mast structure 130. Once the desired vertical position is achieved, the mast structure 130 is then moved in a lateral (e.g., transverse, etc.) direction about the sub-frame assembly 110 until the deployed position is achieved. According to various alternative embodiments, in certain applications, the side loading vehicle system 100 may move in a vertical direction and a lateral direction simultaneously at certain points during deployment and/or retraction.

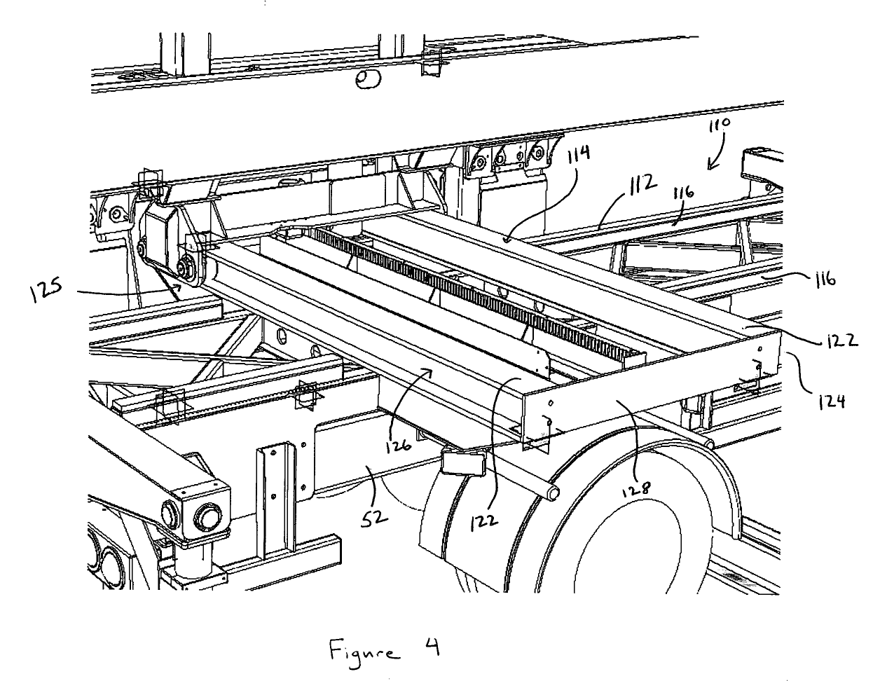

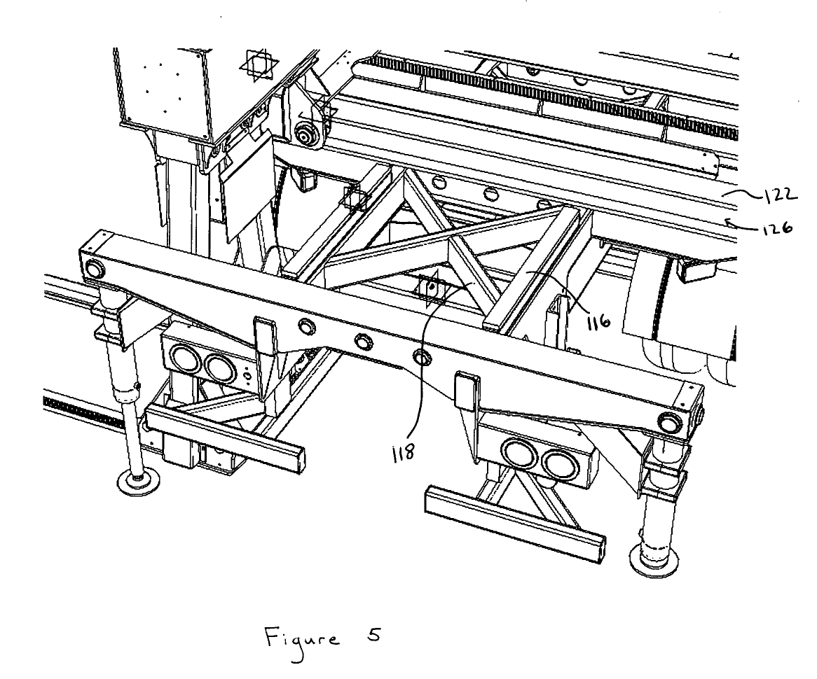

Referring to FIGS. 4 and 5, the sub-frame assembly 110 of the side loading vehicle system 100 is shown according to an exemplary embodiment. The sub-frame assembly 110 is supported by the chassis 52 and generally comprises a first or longitudinally extending portion 112 (i.e., extending in a fore and aft direction of the carrier 50) and a second or laterally extending portion 114. The first portion 112 may be provided as a separate structure relative to the second portion 114, or alternatively, may be integrally formed with the second portion 114. The second portion 114 may be disposed above, below, and/or within substantially the same vertical plane as the first portion 112.

The first portion 112 of the sub-frame assembly 110 is shown as generally comprising first and second frame sections 116 that are arranged as two generally parallel sections extending in a fore and aft direction between an area behind the cab 56 (e.g., an area adjacent to a headboard 58, shown with an emergency light package 60, etc.) and a distal end 62 of the carrier 50. The first and second frame sections 116 are configured as elongated structural or supportive sections (e.g., a beam, channel, tubing, extrusion, etc.) and are generally disposed about the first and second frame members of the chassis 52. The first and second frame sections 116 may be substantially continuous or comprised of intermittent sections. The sub-frame assembly 110 may include one or more support members, shown as cross-bars 118, for improving the rigidity and/or torsional strength of the first and second frame sections 116.

Referring to FIG. 5 in particular, the first portion 112 of the sub-frame assembly 110 is configured to allow a secondary or supplementary towing apparatus to be used in conjunction with the carrier 50. For example, the first portion 112 is generally open along the centerline of the chassis 52 to allow a wheel lift or underlift system to be movably coupled the sub-frame assembly 110 and/or the chassis 52. Extensible wheel lift and underlift systems are generally know and the first portion 112 may be configured to receive such systems or any other suitable wheel lift or underlift systems. According to an exemplary embodiment, the first portion 112 is configured to receive a wheel lift apparatus similar to the one disclosed in U.S. Pat. No. 6,231,294, entitled “Independent Wheel-Lift Having a Chassis Mounted Pivot Point,” issued to Young et al. on May 15, 2001, and assigned to Jerr-Dan Corporation, or the one disclosed in U.S. Pat. No. 5,951,235, entitled “Advanced Rollback Wheel-Lift,” issued to Young et al. on Sep. 14, 1999, and assigned to Jerr-Dan Corporation, the disclosures of which are incorporated by reference herein in their entirety.

The second portion 114 of the sub-frame assembly 110 generally comprises one or more frame sections 120 extending in a direction that is substantially perpendicular to the first portion 112 of the sub-frame assembly 110. The second portion 114 allows for the lateral movement of the side loading vehicle system 100. According to the exemplary embodiment illustrated, the second portion 114 comprises first and second frame members 122 that are arranged as two generally parallel rails extending in a lateral direction between a first end 124 (which overhangs or otherwise extends beyond one side of the chassis 52) and a second end 125 (which overhangs or otherwise extends beyond an opposite side of the chassis 52). The first and second frame members 122 are configured as elongated structural or supportive members (e.g., a beam, extrusion, etc.) which define channels 126. Provided at each end of the first and second frame members 122 is an end plate 128 configured to secure the first and second frame members 122 relative to each other.

According to an exemplary embodiment, the second portion 114 of the sub-frame assembly 110 is supported substantially above and parallel with the rear axle of the carrier 50. Positioning the second portion 114 over the rear axle advantageously allows a substantial portion of the overall weight of the side loading vehicle system 100 to be positioned over the rear wheels. According to various alternative embodiments, the second portion 114 may be positioned in any of a variety positions along the chassis 52. According to an exemplary embodiment, the second portion 114 is coupled to the first portion 112 and/or the chassis 52 using one or more suitable techniques (e.g., mechanical fasteners, a welding process, etc.).

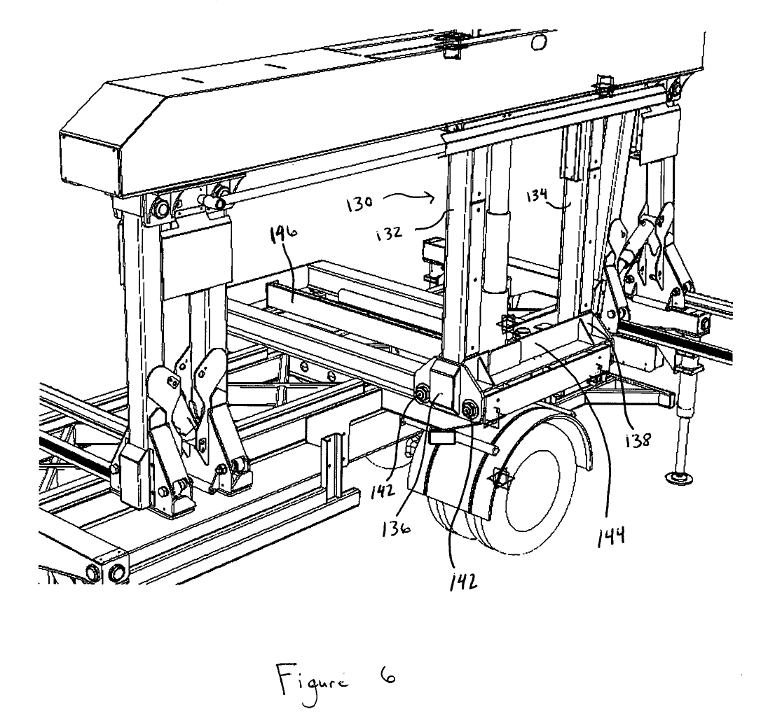

Movably supported relative to the second portion 114 of the sub-frame assembly 110 is the mast structure 130. The mast structure 130 is configured to reciprocatingly move along the second portion 114 in a lateral direction between the first end 124 and the second end 126 of the first and second frame members 122. FIGS. 6-9 show the mast structure 130 according to an exemplary embodiment. According to the illustrated embodiment, the mast structure 130 is shown as comprising a first or front upright member 132 and a second or rear upright member 134. The mast structure 130 is further shown as comprising a cross support 136 (shown in FIG. 1) coupled near the tops of the first and second uprights 132, 134 for providing extra strength and stability to the mast structure 130.

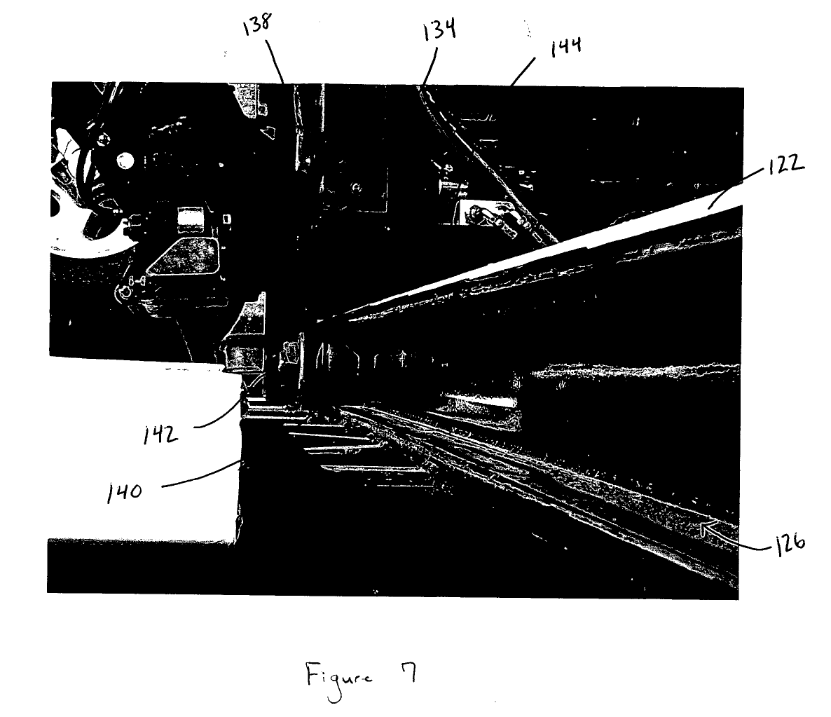

Referring to FIG. 6 in particular, the first and second uprights 132, 134 are shown as having lower ends 136 and 138 respectively. The lower ends 136, 138 are movably (e.g., slidably, etc.) supported relative to the first and second frame members 122. According to an exemplary embodiment, the lower ends 136, 138 are configured to movably engage the first and second frame members 122. Referring to FIG. 7 in particular, the lower ends 136, 138 each include one or more rollers 140 configured for guided movement within the channels 126 defined by the first and second frame members 122. According to the embodiment illustrated, each lower end 136, 138 includes two rollers 140 rotatably coupled to the respective lower end 136, 138 about a pin or shaft 142.

Providing single rows of rollers 140 configured to move between two surfaces (e.g., a top and bottom inner surfaces of the channels 126, etc.) advantageously provides a reduced profile (e.g., a compact configuration, etc.) in comparison to a system having two rows of rollers, each row provided on opposed outer surfaces of a guide structure. According to various alternative embodiments, any of a number of rollers, in any number of rows, may be provided for the reciprocal movement of the first and second uprights 132, 134 relative to the second portion 114. According to further alternative embodiments, the rollers may be replaced or used in conjunction with any suitable mechanism for providing reciprocal linear moment (e.g., track mechanisms, bearing surface, guide and follower, wear pads, etc.).

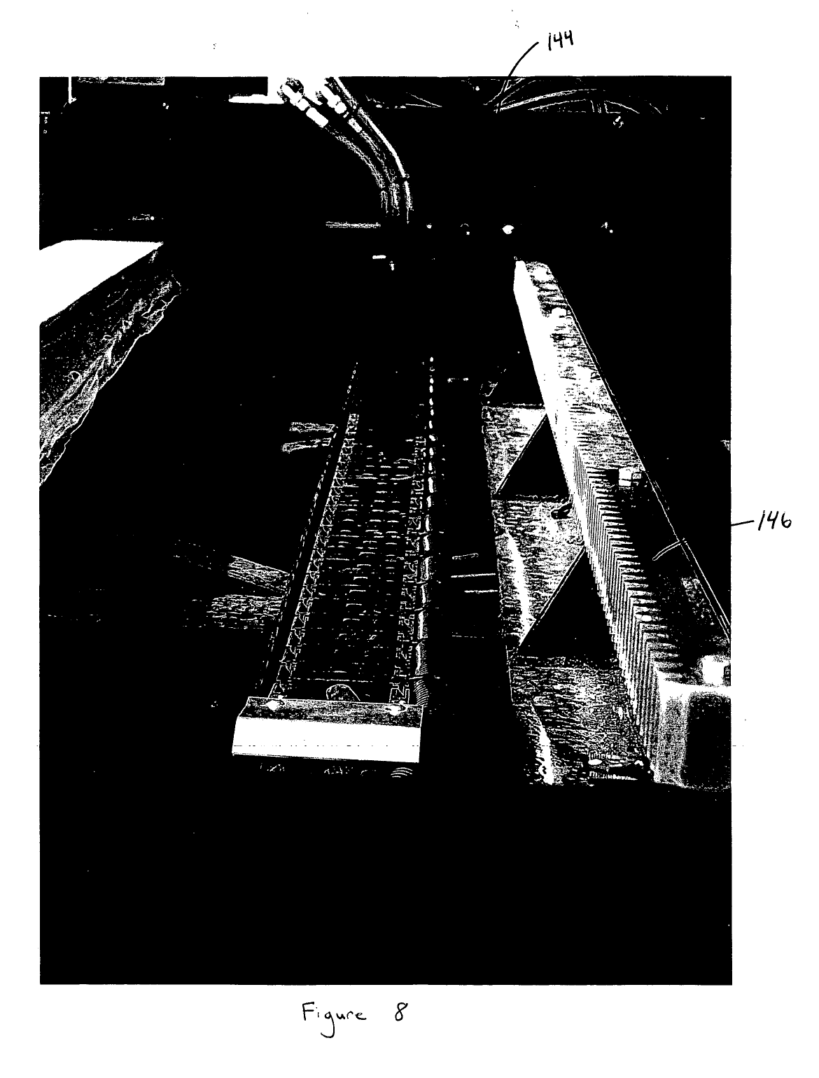

Referring further to FIG. 6, provided between the lower ends 136, 138 of the first and second uprights 132, 134 is a carriage 144. The carriage 144 may be incorporated to provide extra strength and stability to the mast structure 130. According to an exemplary embodiment, the carriage 144 is configured to supported a drive mechanism or actuator device (not shown) configured to selectively move the mast structure 130 relative to the second portion 114 of the sub-frame assembly 110. Referring to FIG. 8 in particular, the drive mechanism is a motor having an output shaft fitted with a spur gear configured to be in meshing engagement with a gear rack 146. The gear rack 146 is coupled to the sub-frame assembly 110 and is positioned substantially parallel with the first and second frame members 122 of the second portion 114. According to various alternative embodiments, any of a number of drive mechanisms or actuator devices may be used to move the mast structure 130 relative to the second portion 114 such as pneumatic, electrical, and/or hydraulic cylinders, etc.

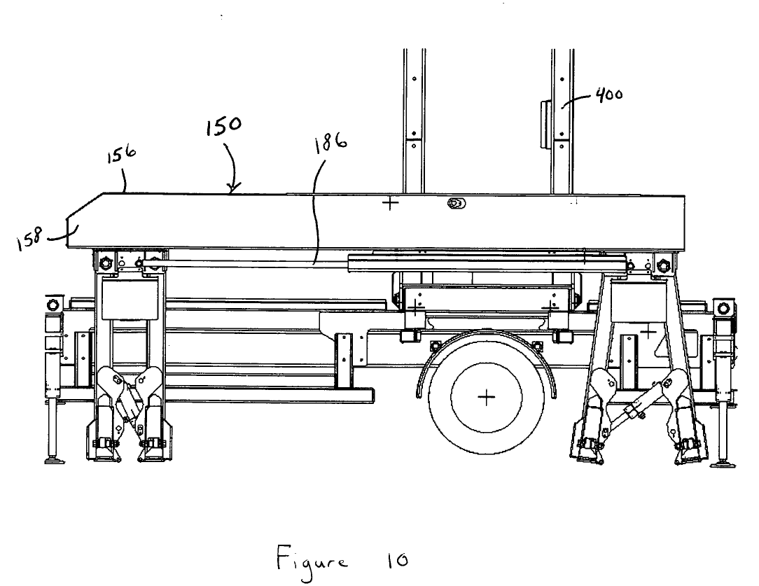

Movably supported relative to the mast structure 130 is the boom assembly 150. The boom assembly 150 is configured to move between a lowered position (shown in FIG. 1) and a raised position (shown in FIG. 2). The mast structure 130 guides the boom assembly 150 as the boom assembly 150 moves between the lowered position and the raised position. FIGS. 10 through 12 show the boom assembly 150 according to an exemplary embodiment. The boom assembly 150 extends in a fore and aft direction between a first or rear end 152 and a second or front end 154.

According to an exemplary embodiment, the boom assembly 150 is defined, at least in part, by a top surface 156, a first side surface 158 (shown in FIG. 1), and a second side surface 160 (shown in FIG. 3). The side surfaces 158 and 160 may provide a surface upon which a user can display indicia, symbols, nomenclature (e.g., a company name, logo, and/or telephone number, etc.). The top surface 156 defines an opening 162 (shown in FIG. 1) to allow the mast structure 130 to extend therethrough when the boom assembly 150 is in the lowered position. The combination of the top surface 156, the side surface 158 and the side surface 160 defines a cavity or channel 164. As detailed below, the channel 164 is configured to house and/or conceal certain components of the side loading vehicle system 130.

The raising and lowering of the boom assembly 150 relative to the mast structure 130 is achieved using an actuator device 166. According to an exemplary embodiment, the actuator device 166 is a hydraulic actuator device. For example, as shown in FIG. 3, the actuator device 166 comprises a hydraulic cylinder having a first end 168 coupled to the carriage 144 and a second end 170 coupled to boom assembly 150. According to a preferred embodiment, the hydraulic cylinder is a three-stage telescopic cylinder. According to various alternative embodiments, the actuator device 166 may be any other type of actuator capable of producing mechanical energy for exerting forces suitable to lift the boom assembly 150 when a load (e.g., a disabled vehicle, etc.) is engaged by the side loading vehicle system 100. For example, the actuator device 166 can be pneumatic, electrical, a power screw, rack and pinion configuration, or any other suitable actuator device.

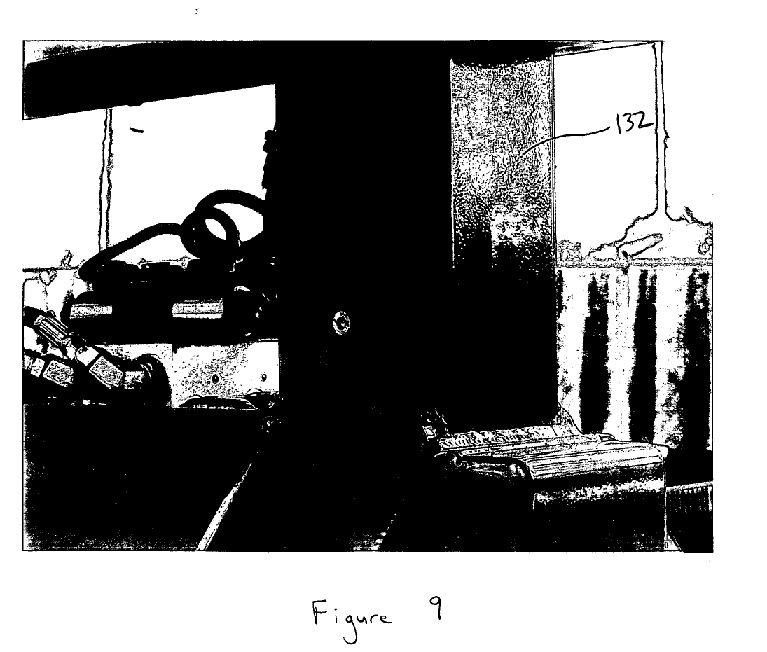

Referring to FIG. 9, a slide bearing or wear pad 400 is provided between the mast structure 130 and the boom assembly 150 to reduce the friction as the boom assembly 150 moves relative to the mast structure 130. According to the embodiment illustrated, the wear pad 400 is coupled to the mast structure 130. Referring back to FIGS. 6 and 10, wear pads 400 are shown as being coupled to both the first and second uprights 132, 134 of the mast structure 130. Preferably, the wear pads 400 are high compression wear pads for reduced localized deformation. For example, according to an exemplary embodiment, the wear pads 400 are formed of a phenolic graphite based material. The wear pads 400 advantageously allow for a compact configuration. According to various alternative embodiments, wear pads or bearing surfaces formed of any of a variety of suitable materials may be used. According to further alternative embodiments, other suitable mechanisms may be used to reduce the sliding friction between the boom assembly 150 and the mast structure 130 including, but not limited to, rollers.

Supported by the boom assembly 150 are the one or more vehicle engaging arms 180. According to an exemplary embodiment, a pair of vehicle engaging arms 180 are supported by the boom assembly 150 and extend downwardly therefrom in a generally vertical direction. Referring further to FIG. 1, the boom assembly 150 supports a first or front engaging arm 182 and a second or rear engaging arm 184. The front engaging arm 182 is configured to engage one of the front wheels and the rear wheels of a vehicle to be transported depending on how the carrier 50 approaches the vehicle to be transported, while the rear engaging arm 184 is configured to engage the other of the front wheels and the rear wheels of the vehicle to be transported. According to various alternative embodiments, the vehicle engaging arms 180 may be configured to engage other portions of the vehicle to be transported (e.g., vehicle frame, structural portions, axles, etc.).

According to an exemplary embodiment, at least one of the front engaging arm 182 and the rear engaging arm 184 is selectively movable relative to the boom assembly 150 in a fore and aft direction of the carrier 50 to accommodate vehicles having varying wheelbase lengths. According to the embodiment illustrated in FIGS. 10 through 12, the front engaging arm 182 is movably supported relative to the boom assembly 150, while the rear engaging arm 184 is fixedly coupled to the boom assembly 150. According to various alternative embodiments, the rear engaging arm 184 may be movably supported relative to the boom assembly 150, while the front engaging arm 182 is fixedly coupled to the boom assembly 150. According to further alternative embodiments, both the front engaging arm 182 and the rear engaging arm 184 may be movably supported relative to the boom assembly 150 or fixedly coupled to the boom assembly 150. In such a configuration, movement of the front engaging arm 182 and the rear engaging arm 184 may dependent or independent of each other.

According to an exemplary embodiment, the side loading vehicle system 100 can be used to lift vehicles with wheelbase lengths ranging from around 85 inches to around 145 inches. Further, the side loading vehicle system 100 can be used to engage and lift vehicles weighing up to approximately 6000 pounds. According to various alternative embodiments, the side loading vehicle system 100 may be configured to accommodate vehicles having a wheelbase length greater than 145 inches and/or less than 85 inches. Further, the side loading vehicle system 100 may be configured to support loads weighing more than 6000 pounds.

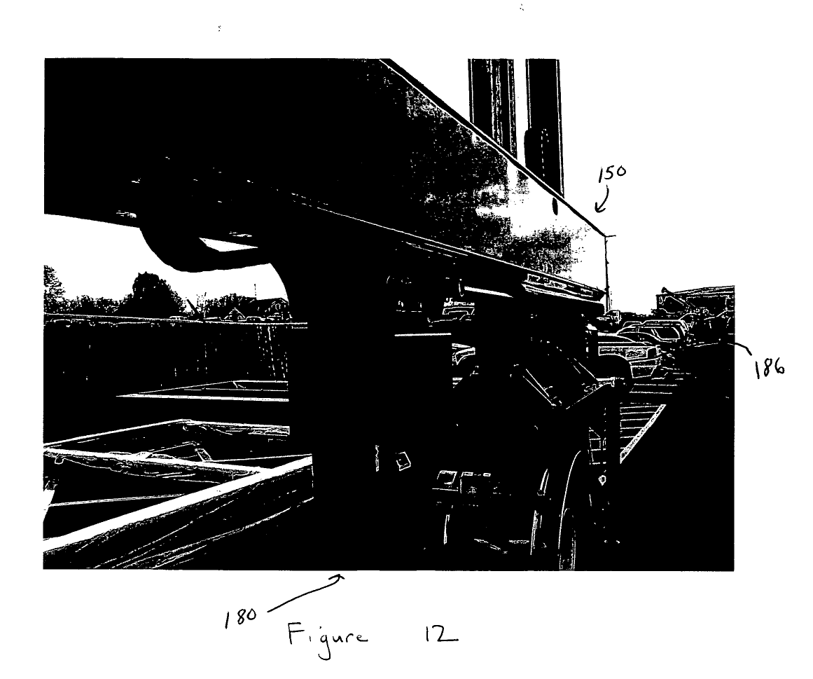

Referring further to FIGS. 10 and 12, the reciprocal movement of the front engaging arm 182 relative to the boom assembly 150 in a fore and aft direction is achieved using an actuator device 186. According to an exemplary embodiment, the actuator device 186 is a hydraulic actuator device comprising a hydraulic cylinder having a first end 188 fixedly coupled relative to the boom assembly 150 and a second end 190 coupled to the front engaging arm 182. According to various alternative embodiments, the actuator device 186 may be any other type of actuator capable of producing mechanical energy for exerting forces suitable to moving the front engaging arm 182. For example, the actuator device 186 can be pneumatic, electrical, a power screw, rack and pinion configuration, or any other suitable actuator device.

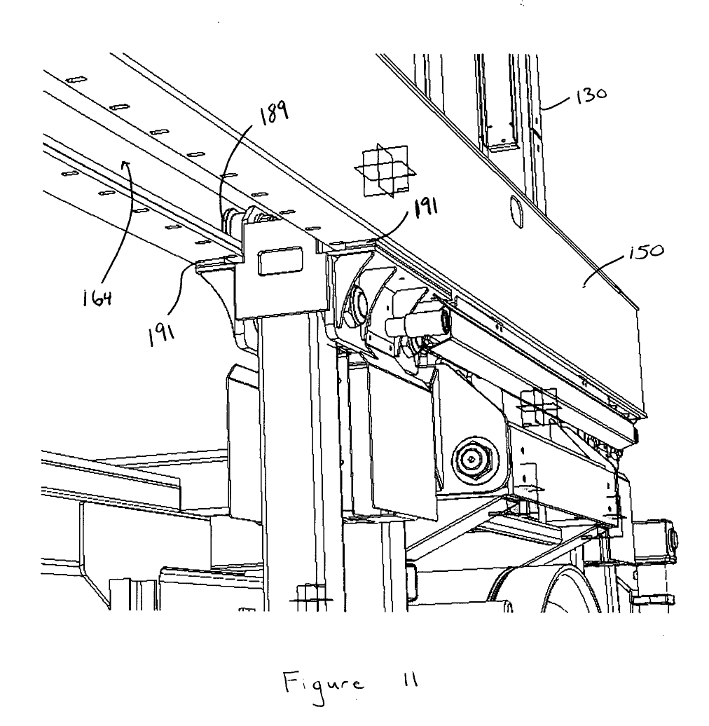

Referring further to FIG. 11, one or more slide mechanisms are provided between the front engaging arm 182 and the boom assembly 150 to reduce the sliding friction between the front engaging arm 182 and the boom assembly 150. According to the embodiment illustrated, the slide mechanism comprises at least one roller 189 configured to rotatably engage the boom assembly 150 within the channel 164 of the boom assembly 150. A wear pad 191 is provided on the front engaging arm 182 that is configured to slidably engage the boom assembly 150 on a side opposite the roller 189. According to various alternative embodiments, any of variety of suitable slide mechanism may be used to reduce the sliding friction between front engaging arm 182 and the boom assembly 150 as the front engaging arm 182 moves in a fore and aft direction.

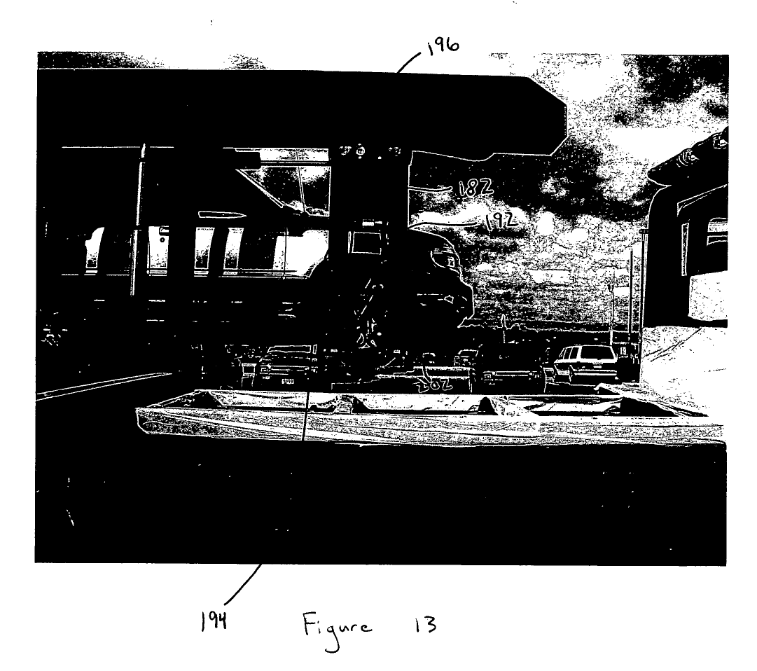

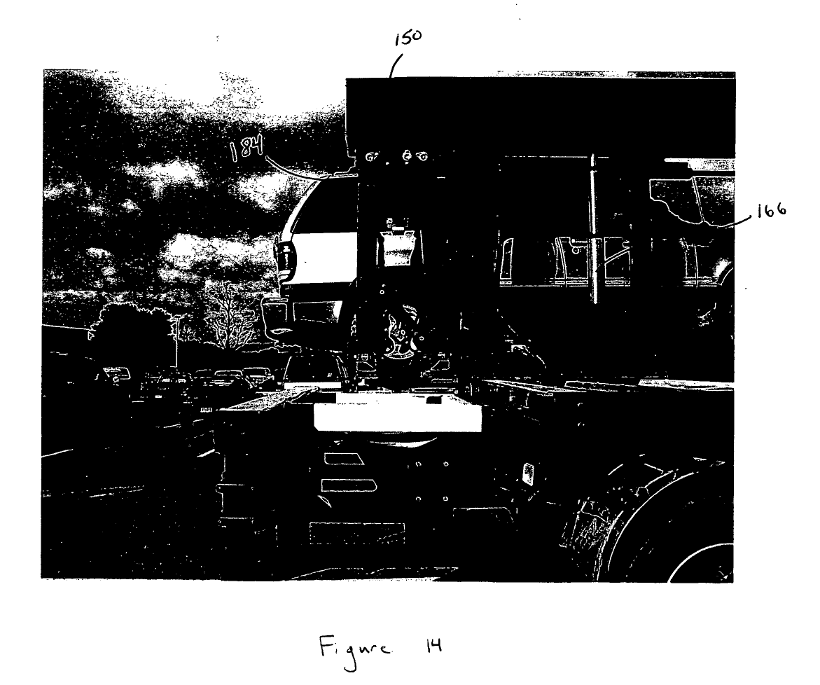

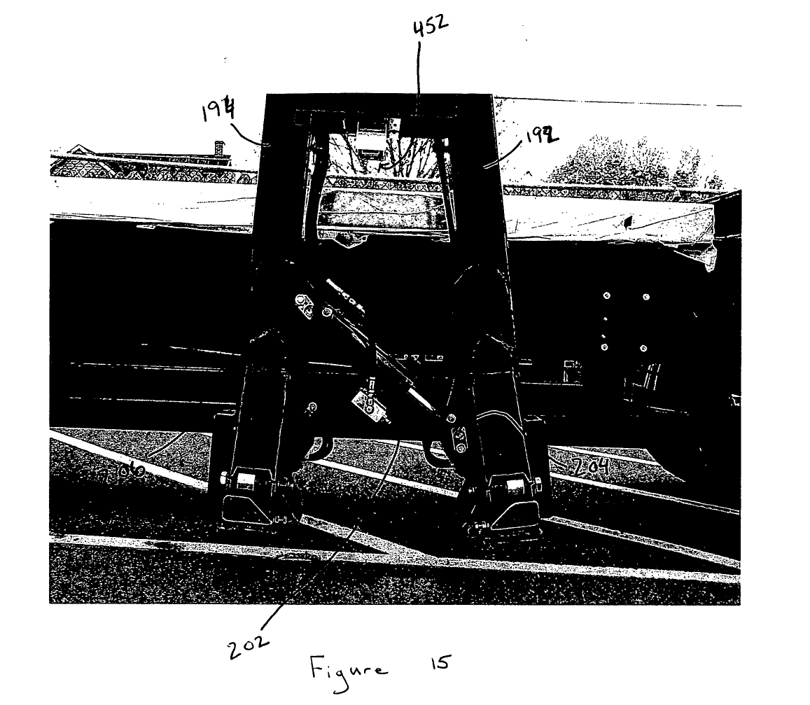

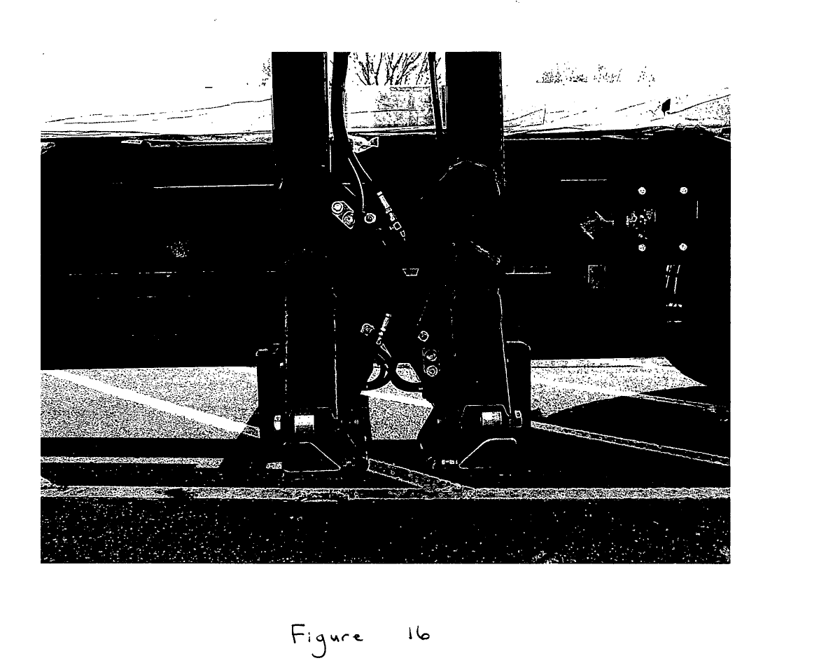

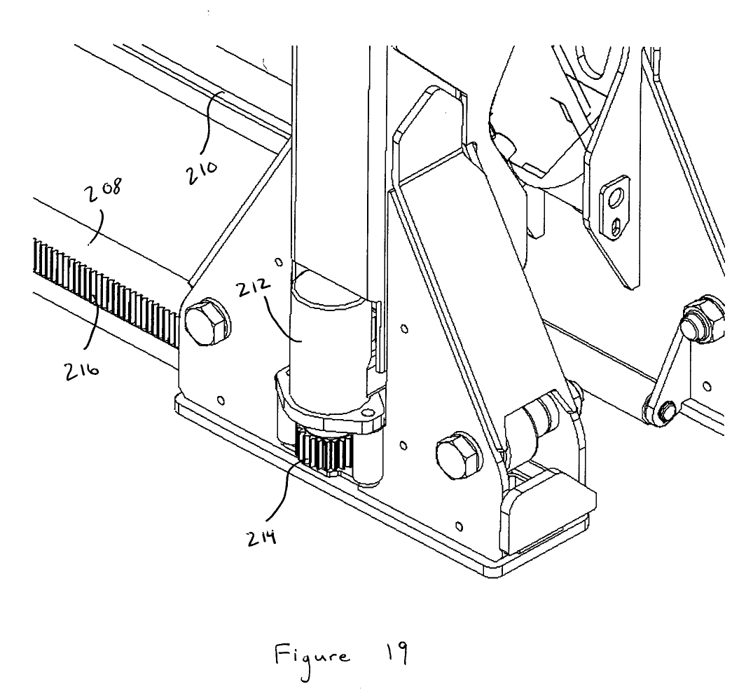

Referring to FIGS. 13 through 19, the vehicle engaging arms 180 are shown according to an exemplary embodiment. FIG. 13 shows an exemplary embodiment of the front engaging arm 182, while FIG. 14 shows an exemplary embodiment of the rear engaging arm 184. The front engaging arm 182 and the rear engaging arm 184 are configured to move between a first or open position (shown in FIG. 15) and a second or closed position (shown in FIG. 16). In the open position, the engaging arms are configured to be disposed about the wheels of the vehicle to be transported (e.g., to release the wheels, etc.), while in the closed position, the engaging arms are configured to engage the wheels of the vehicle to be transported (e.g., to secure the wheels, etc.).

Providing a front engaging arm 182 configured to move between the open position and the closed position, advantageously allows the front engaging arm 182 to adjust to the size of the wheel being engaged and/or to more easily engage or release the wheel.

According to an exemplary embodiment, the configuration of the front engaging arm 182 and the rear engaging arm 184 are substantially identical. Accordingly, for brevity, only the configuration of the front engaging arm 182 will be described in detail herein. Referring to FIG. 13, the front engaging arm 182 generally comprises a first support member, shown as a first upright portion 192, and a second support member, shown as a second upright portion 194. The first and second upright portions 192 and 194 are shown as being spaced apart in a fore and direction of the carrier 50. A top end of the first upright portion 192 is pivotally coupled to a support bracket 196 about a pivot shaft 198, while a top end of the second upright portion 194 is pivotally coupled to the support bracket 196 about a pivot shaft 200. The support bracket 196 is supported relative to the boom assembly 150. The support bracket 196 may be movably or fixedly supported relative to the boom assembly 150.

According to the embodiment illustrated, the first upright portion 192 and the second upright portion 194 are configured to move (e.g., rotate, slide, swing, etc.) outwardly (i.e., widen in a fore and aft direction of the carrier 50) relative to each other about the pivots shafts 198, 200 respectively to achieve the open position. According to the various alternative embodiments, only one of the first upright portion 192 and the second upright portion 194 may be configured to move while the other of the first upright portion 192 and the second upright portion 194 remains in a fixed position.

The movement (e.g., rotation, etc.) of the first upright portion 192 and the second upright portion 194 relative to each other is achieved using an actuator device 202. According to an exemplary embodiment, the actuator device 202 is a hydraulic actuator device comprising a hydraulic cylinder having a first end 204 coupled to the first upright portion 192 and a second end 206 coupled to second upright portion 194. According to a preferred embodiment, the hydraulic cylinder is a double acting cylinder configured to angularly displace the first upright portion 192 relative to the second upright portion 194 when selectively actuated by a user. According to various alternative embodiments, the actuator device 202 may be any other type of actuator capable of producing mechanical energy for exerting forces suitable to angularly displace the first upright portion 192 and the second upright portion 194 relative to each other. For example, the actuator device 202 can be pneumatic, electrical, or any other suitable actuator device.

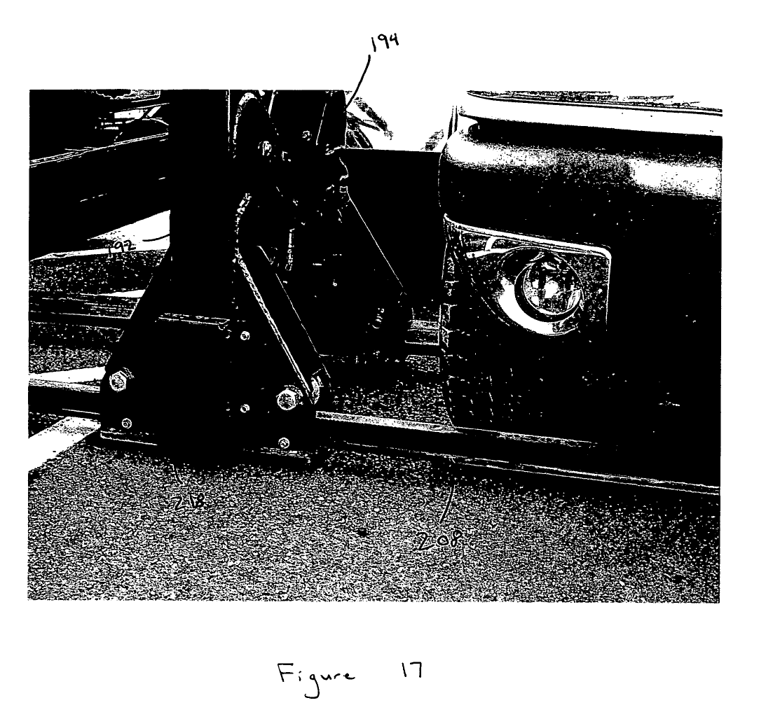

Referring to FIGS. 17 through 19 in particular, a pair of prongs or forks are retractably supported to the vehicle engaging arms 180. Referring particularly to the front engaging arm 182, each first and second upright portions 192, 194 is configured to retractably support a fork 210. The forks 210 can be selectively reconfigured or maneuvered to extend to a position suitable for lifting loads from a first lateral side of the carrier 50 or from the a second lateral side of the carrier 50, and to assume any position in between. According to an exemplary embodiment, the forks 210 outwardly extend from the first and second upright portions 192, 194 to engage the wheels of the vehicle to be transported.

Providing forks 210 that are retractably supported to the first and second upright portions 192, 194 allows the carrier 50 to engage a lateral side of the vehicle to transported regardless of the direction of the carrier 50. For example, if the carrier 50 was on a one-way street, with vehicles parked along both sides of the street, the carrier 50 could recover a vehicle on either side by simply selectively adjusting the positioning of the forks 210.

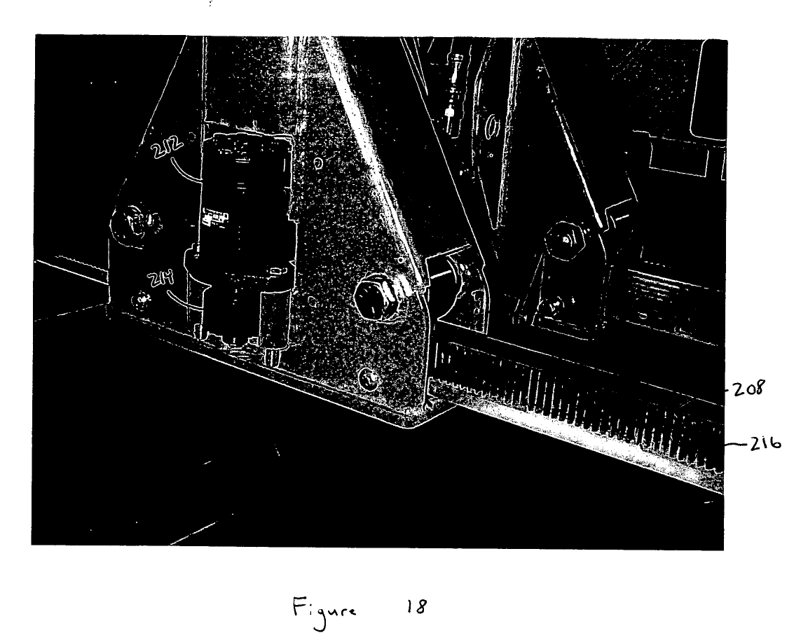

The reciprocal movement of the forks 219 relative to the first and second upright portions 192, 194 is achieved using a gear rack and pinion type configuration. For example, referring to FIG. 18 in particular, each of the first and second upright members 192, 194 is shown comprising a motor 212 having an output shaft fitted with a spur gear 214 configured to be in meshing engagement with a gear rack 216. The motors 212 are vertically mounted along an outer portion of the first and second upright portions 192, 194. To protect the motors 212 from contaminants or foreign objects, covers 218 (shown in FIG. 17) are disposed over the motors 212.

The gear rack 216 that is engaged by the spur gear 214 is supported by the forks 210. According to a preferred embodiment, the gear rack 216 is integrally formed with the forks 210 along an outer side surface of the forks 210. The inner surface of the forks 210 may include an at least partially angled, sloped, beveled, and/or curvilinear edge for engaging the wheels of the vehicle to be towed. According to various alternative embodiments, the gear rack 216 may be a separate member that is coupled to forks 210. According to various alternative embodiments, any of a number of drive mechanisms or actuator devices may be used to move the forks 210 relative to the vehicle engaging arms 180 such as pneumatic, electrical, and/or hydraulic cylinders, drive chains, power screws, etc.

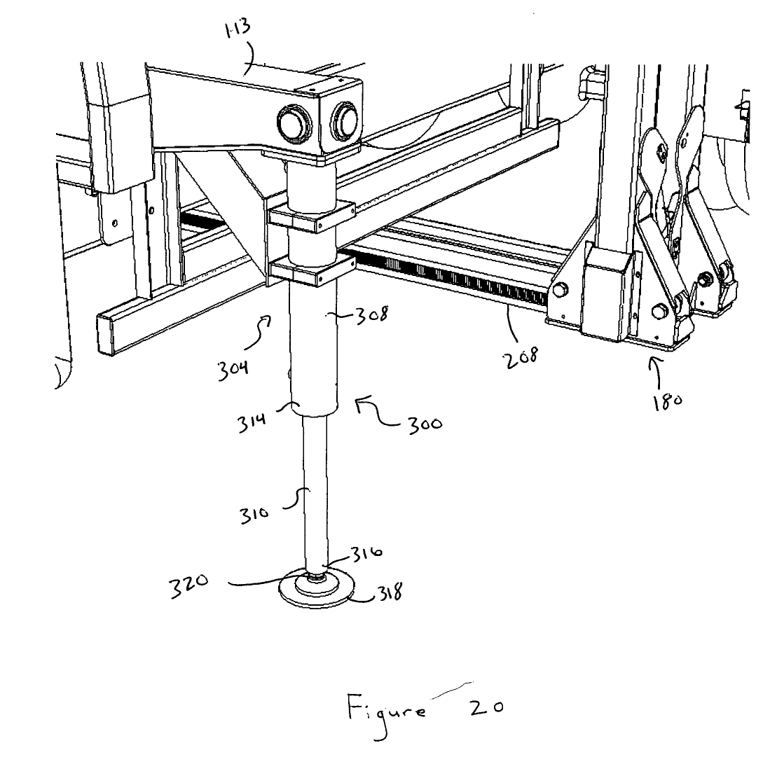

Referring to FIGS. 5 and 20, the side loading vehicle system 100 is further shown as including the outrigger system 300 for stabilizing the carrier 50 during operation of the side loading vehicle system 100, particularly when operation of the vehicle engaging arms 180 are outwardly of a lateral side of the carrier 50 (as shown in FIGS. 1 and 2). The outrigger system 300 generally includes four outriggers (e.g., jacks, extensions, supports, etc.), shown as a pair of front outriggers 302 and a pair of rear outrigger 304. The pair of front outriggers 302 and the pair of rear outriggers 304 are preferably coupled to an outermost lateral portion of the sub-frame assembly 110. Referring to back to FIG. 1, the pair of front outriggers 302 are supported at a front cross bar member 111, while the pair of rear outriggers 304 are supported at a rear cross bar member 113. According to various alternative embodiments, any number of outriggers may be provided, at any of a number of positions, along the sub-frame assembly 110 and/or the chassis 52 for stabilizing the carrier 50.

The pair of front outriggers 302 and the pair of rear outriggers 304 are selectively movable between a retracted stowed or transport position (shown in FIG. 5 for a right rear outrigger 304) and an extended use or stabilizing position (shown in FIG. 5 for a left rear outrigger 304). With the pair of front and rear outriggers 302 and 304 in the extended position, the outrigger system 300 provides a wider base or stance for stabilizing the carrier 50. The outrigger system 300 may be capable of stabilizing the carrier 50 in a lateral direction as well as a fore and aft direction.

The configuration of the front outriggers 302 is substantially identical to the configuration of the rear outriggers 304. Accordingly, for brevity, only the configuration of the rear outriggers 304 is described in detail herein. Referring to FIG. 20, the second outriggers 304 generally include a base support member 308, one or more extensible support members (shown as a first extension member 310), and a ground engaging portion 312.

A first end 312 of the base support member 308 is coupled to the sub-frame assembly 110 at the rear cross bar member 113. The base support member 308 is preferably a tubular member having a second end 314 configured to receive a first end of the first extensible member 310. The first extensible member 310 is configured for telescopic extension and retraction relative to the base support member 308. The telescopic extension and retraction of the first extensible member 310 may be achieved manually, hydraulically, pneumatically, and/or electrically. According to various alternative embodiments, any suitable actuator device may be used for the extension and retraction of the rear outriggers 304.

For purposes of this disclosure, the free end or end-most portion of the furthest extensible member is referred to as a distal end 316. The distal end 316 of the furthest extensible member (e.g., the first extensible member 310, etc.) includes a ground engaging portion 318. The ground engaging portion 318 distributes the load at end distal end 316 over a greater area. The ground engaging portion 318 may be fixedly coupled at the distal end 316, or alternatively, may be movably coupled at the distal end 316. Referring further to FIG. 20, a swivel base or ball and socket type configuration 320 is provided between the ground engaging portion 318 and the first extension member 310. Movably coupling the ground engaging portion 318 to the distal end 316 allows the ground engaging portion 318 to provide a stable footing on uneven surfaces. The ground engaging portion 318 may optionally include a structure to facilitate engaging a surface and thereby reduce the likelihood that the carrier 50 will undesirably slide or otherwise move in a lateral direction during operation of the side loading vehicle system 100. For example, the ground engaging portion 318 may include one or more projections (e.g., teeth, spikes, etc.) configured to penetrate the surface for providing greater stability. It should also be noted that each of the outriggers may be operated independently of each other in such a manner that the carrier 50 may be stabilized even when positioned on an uneven or otherwise non-uniform surface.

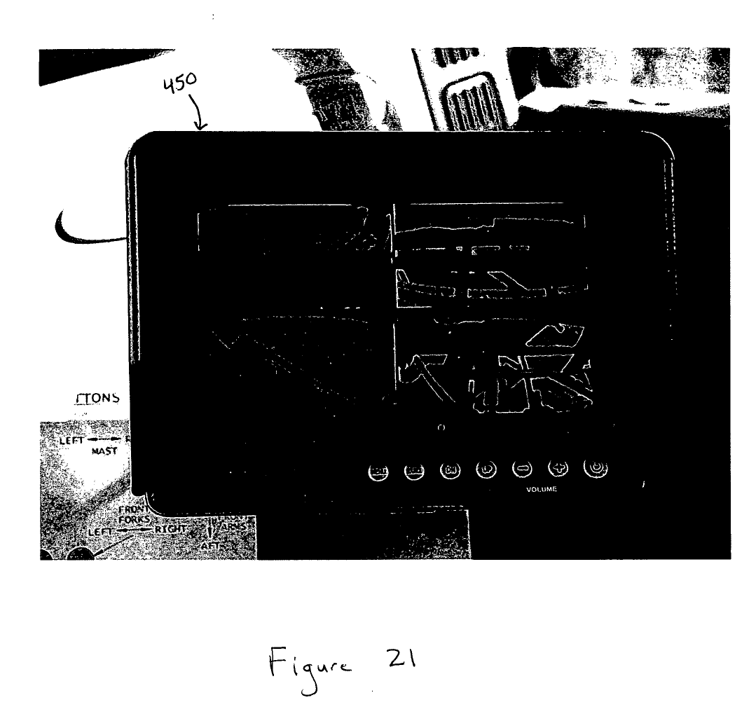

Referring to FIG. 21, the side loading vehicle system 100 may optionally include a surveillance or monitoring system which would allow an operator of the carrier 50 to operate and selectively position the side loading vehicle system 100 while remaining in the cab 56. According to an exemplary embodiment, a display monitor or screen 450 (e.g., LCD display, etc.) is provided within the cab 56. The display screen 450 is configured to display images of select portions of the side loading vehicle system 100. The images are captured by one or more imaging devices, shown as cameras 452, selectively positioned about the carrier 50. According to an exemplary embodiment, a total of four camera 452 are employed, with each camera providing a video image to a quadrant on the display screen 450.

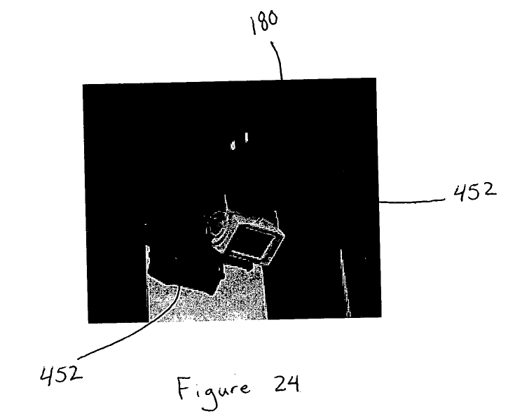

Referring back to FIG. 15, cameras 452 are shown coupled to each vehicle engaging arm between the first and second upright portions 192, 194 and face downward towards the forks 210. According to the embodiment illustrated, two cameras 452 are provided at such location, with one camera tilted (e.g., angularly displaced, etc.) towards a first lateral side of the vehicle engaging arm 180 and another camera tilted towards a second lateral side of the vehicle engaging arm 180 as shown in FIG. 24. Such positioning allows an operator to view the positioning of the forks 210 as the forks 210 extend and/or retract from each lateral side of the vehicle engaging arm 180. Preferably, the cameras 452 have infrared backlighting for nighttime or low light applications.

According to various alternative embodiments, any number of cameras, provided at any of a number of positions, may be used to provide an operator with a visual display of the positioning of the side loading vehicle system 100 without requiring the operator to leave the cab 56. Further, the cameras may be supported in a fixed position, or alternatively, the orientation of the camera may be selectively reconfigurable by the operator.

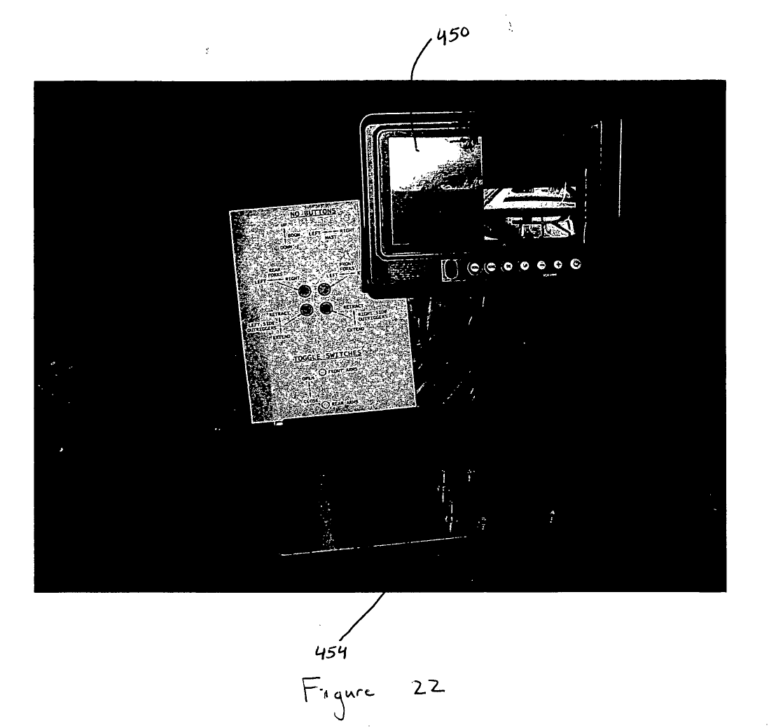

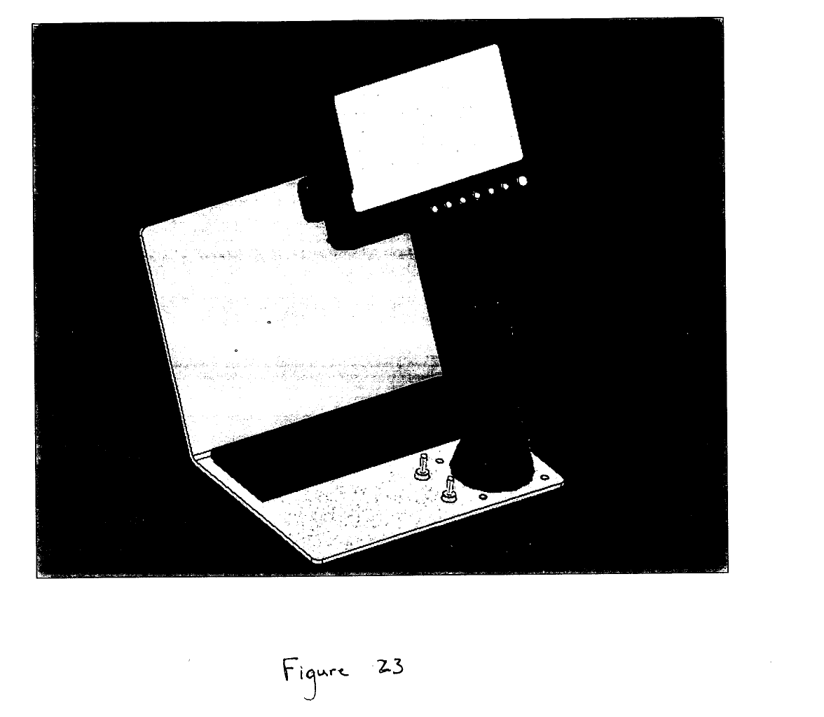

To control of the movement of the side loading vehicle system 100, a user interface is provided. The user interface may be located within the cab 56, or alternatively, the user interface may be located outside of the cab 56. FIGS. 22 through 23 show a user interface according to an exemplary embodiment. The user interface is configured as joystick controller 454. The controls of the side loading vehicle system 100 are based on a CAN (multiplexing) electrical system. According to various alternative embodiments, the controls and/or the user interface may be any of a variety of suitable systems.

The movement and/or operation of the side loading vehicle system 100 will be described with reference to FIGS. 1 through 3, which show the side loading vehicle system 100 moving from the deployed position to the retracted. In FIG. 1, the side loading vehicle system 100 has already moved from the retracted position to the deployed position. To reach this position, the operator, using the joystick controller 454, selectively moved the mast structure 130 laterally about the second portion 114 of the sub-frame assembly 110 and moved the boom assembly downward in a vertical direction relative to the mast structure 130. While FIG. 1 shows the forks 210 as being fully extended in a lateral direction away from the carrier 50, during an actual recovery application, the forks 210 would not be extended until the carrier 50 is adjacent to the vehicle to be transported and the vehicle engaging portions 180 are substantially aligned with the wheels of the vehicle to be transported. Prior to being outwardly extending, the forks 210 would be substantially disposed beneath the chassis 52 when the boom assembly 150 is lowered relative to the mast structure 130.

Once the carrier 50 is adjacent to the vehicle to be transported, the vehicle engaging arms 180 are substantially aligned with the wheels of the vehicle to be transported (e.g., by selectively moving the front engaging arm 182 relative to the boom assembly 150, etc.), the vehicle engaging arms 180 are preferably moved to an open position with the forks 210 outwardly extending therefrom. The engaging arms 180 are then selectively moved to the closed position by actuating the actuator device 202. As the engaging arms 180 move to towards the closed position, the wheels of the vehicle to be transported become engaged by the forks 210.

With the wheels of the vehicle to be transported cradled by the forks 210, the operator may selectively raise the vehicle by actuating the actuator device 166 which raises the boom assembly 150 relative to the mast structure 130. The boom assembly 150 is raised until the forks 210 are above the sub-frame assembly 110. In the fully raised position, the operator may than move the vehicle over the chassis 52 slide the mast structure 130 in a lateral direction by actuating the motor configured to engage the gear rack 146.

It is important to note that the construction and arrangement of the side loading vehicle system as shown in the various exemplary embodiments are illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed herein. For example, elements shown as integrally formed may be constructed of multiple parts or elements, elements shown as multiple parts may be integrally formed, the position of elements may be reversed or otherwise varied, and the nature or number of discrete elements or positions may be altered or varied. Accordingly, all such modifications are intended to be included within the scope of the present invention as disclosed herein. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

What is claimed is:

1. A side-loading vehicle lifting apparatus comprising:
a frame assembly;
a mast structure movably supported by the frame assembly and configured for horizontal movement relative to the mast structure in a lateral direction;
a boom movably supported by the mast structure and configured for vertical movement relative to the mast structure; and
at least one arm assembly supported by the boom, the arm assembly having a width in a fore and aft direction that is expandable and retractable using an actuator device.

2. The lifting apparatus of claim 1, wherein the frame assembly is a sub-frame configured to be supported by a chassis of a recovery vehicle.

3. The lifting apparatus of claim 2, wherein the sub-frame comprises a lateral portion configured to extend substantially perpendicular to the chassis of the recovery vehicle.

4. The lifting apparatus of claim 3, wherein the lateral portion defines the horizontal movement of the mast structure.

5. The lifting apparatus of claim 4, wherein the lateral portion defines a channel configured to receive a roller coupled to the mast structure.

6. The lifting apparatus claim 4, wherein a rack and pinion configuration is provided to move the mast structure in the horizontal direction relative to the lateral portion of the sub-frame.

7. The lifting apparatus of claim 1, wherein the at least one support arm comprises a first arm assembly and a second arm assembly, the first arm assembly being provided at a first end of the boom and the second arm assembly being provided at an opposite second end of the boom.

8. The lifting apparatus of claim 7, wherein the first arm assembly is movably supported relative to the boom and configured to move in the fore and aft direction to accommodate various sized loads.

9. The lifting apparatus of claim 7, wherein the second arm assembly is fixedly supported relative to the boom.

10. The lifting apparatus of claim 8, wherein a second actuator device is provided to move the first arm assembly in the fore and aft direction.

11. The lifting apparatus of claim 1, wherein the arm assembly comprises a first support member and a second support member coupled to the boom, at least one of the first support member and the second support member are pivotally coupled at a pivot shaft.

12. The lifting apparatus of claim 11, wherein both the first support member is pivotally coupled at a first pivot shaft and the second support member is pivotally coupled at a second pivot shaft, the first pivot shaft and the second pivot shaft supported at a base coupled to the boom. comprise an actuator device coupled between the first upright member and the second upright member.

13. The lifting apparatus of claim 11, wherein a first end of the actuator device is coupled to the first support member and a second end of the actuator device is coupled to the second support member.

14. The lifting apparatus of claim 13, wherein the actuator device is a double-acting hydraulic cylinder.

15. The lifting apparatus of claim 11, wherein the first support member and the second support member are each configured to retractably support a fork configured to engage a vehicle to be towed.

16. The lifting apparatus of claim 15, wherein the fork includes a gear rack, and wherein the first and second support members include a motor having an output gear configured to be in meshing engagement with the gear rack.

17. The lifting apparatus of claim 16, wherein the gear rack is integrally formed with the fork.

18. A recovery vehicle comprising:
a movable chassis having a first lateral side and a second lateral side; and
a side loading vehicle system supported by the movable chassis, the side loading vehicle system comprising:
a sub-frame assembly supported by the chassis;
a mast structure movably supported relative to the sub-frame and configured for lateral movement relative to the chassis;
a boom movably supported relative to the mast structure and configured for vertical movement relative to the mast structure; and
first and second engaging arms supported by the boom and configured to engage wheels of a vehicle to be towed, each engaging arm including a movable support allowing a width of the engaging arm to adjusted,
wherein at least one of the first and second engaging arms are configured to move in a fore and aft direction relative to the boom,
wherein the side loading vehicle system in configured to load vehicles from both the first lateral side and the second lateral side of the chassis.

19. The recovery vehicle of claim 18, wherein the first and second engaging arms each include first and second movable support rotatably coupled to a support bracket.

20. The recovery vehicle of claim 19, wherein the first and second movable supports are configured to support a pair of forks configured to engage the wheels of the vehicle to be towed.

21. The recovery vehicle of claim 20, wherein the forks are configured for reciprocal movement relative to the first and second movable supports to allow the side loading vehicle system to load vehicles from both sides of the chassis.

22. The recovery vehicle of claim 20, wherein the fork is integrally formed with a gear rack configured to be in meshing engagement with gear supported on the first and second movable supports.

23. The recovery vehicle of claim 18, further comprising an outrigger configured to stabilize the recovery vehicle when the side loading vehicle system is engaging a vehicle.

24. The recovery vehicle of claim 23, wherein the outrigger includes an adjustable foot to provide stability on non-uniform surfaces.

25. The recovery vehicle of claim 23, wherein the adjustable foot includes a swivel base.

26. A side loading recovery vehicle comprising:
a chassis having a first lateral side and a second lateral side;
an operator cab supported by the chassis;
a lift system comprising:
a sub-frame assembly supported by the chassis;
a mast structure movably supported relative to the sub-frame and configured for horizontal movement in a lateral direction relative to the chassis;
a boom movably supported relative to the mast structure and configured for vertical movement relative to the mast structure; and
first and second arms supported by the boom and configured to engage a vehicle to be towed from both the first and second lateral sides; and
a surveillance system coupled to the lift system which allows an operator to remain in the operator cab while engaging a vehicle with the lift system.

27. The recovery vehicle of claim 26, wherein the surveillance system comprises at least one imaging device supported near the first and second arms and a display monitor coupled to the imaging device and located in the operator cab.

28. The recovery vehicle of claim 27, wherein the surveillance system comprises a first imaging device at the first arm and a second imaging device at the second arm.

29. The recovery vehicle of claim 28, wherein the first imaging device and the second imaging device each comprises a first video camera directed to the first lateral side and a second video camera directed to the second lateral side.
